(19) United States
(12) Patent Application Publication
(10) Pub. No.: US 2007/0163505 A1
(43) Pub. Date: Jul. 19, 2007

(54) Dispenser feeder with removable rain guard extension

(75) Inventor: John P. Lynch, Burbank, SD (US)

Correspondence Address: MERCHANT & GOULD PC, P.O. BOX 2903, MINNEAPOLIS, MN, 55402-0903, US

(73) Assignee: Sydell Incorporated

(21) Appl. No.: 11/331,508

(22) Filed: Jan. 13, 2006

(51) Int. Cl. A01K 61/02

(52) U.S. Cl. 119/52.1

(57) ABSTRACT

A self-dispensing feeder having a hopper, a feed trough arranged to receive feed from the hopper, and a rain guard. The feeder includes a movable rain guard extension that shields the feed trough from directional rain. The feeder also includes a shielding, overlapping seam arrangement that sheds rain run-off.

### TECHNICAL FIELD

This disclosure relates generally to methods and devices for providing feed to animals. More particularly, this disclosure relates to a self-dispensing feeder, and associated methods of assembling, manufacturing and using a self-dispensing feeder.

### BACKGROUND

A wide variety of arrangements have been utilized for feeding animals in a self-dispensing manner. FIG. 1 illustrates one conventional feeder 10 that is self-dispensing. The feeder 10 includes a hopper 12 and a feed trough 14. The hopper 12 is arranged in relation to the trough 14 such that feed stored within the hopper 12 is self-dispensed, or gravity fed, into the trough 14. A rain guard 16 extends over the feed trough 14. The rain guard 16 is supported by gussets 18.

While the rain guard of such conventional feeder arrangements protects the feed within the trough 14 from a downward rain, conventional rain guards do not protect the feed from directional rain, i.e., rain blown or driven sideward by wind. In conventional arrangements, such as the one shown in FIG. 1, wind can easily blow rain into the feed trough causing feed spoilage and contamination. Further, conventional feeder arrangements typically have seams or joints located between the various feeder components, which are not rain or waterproof. Rain run-off can often seep through the seams and into the hopper or trough also causing feed spoilage and contamination.

In addition, the conventional rain guard arrangements typically have a somewhat flimsy construction that requires structural supports, such as the gussets 18 shown in FIG. 1. Feeding animals or birds sometimes get their heads caught within such structural rain guard supports, often resulting in injury to the animal or bird and damage to the feeder.

In general, improvement has been sought with respect to such feeders, generally to better accommodate: an improved rain protection design, ease of manufacture and assembly, ease of use and maintenance, and improved animal and bird safety.

### SUMMARY

The present disclosure relates to a feeder arrangement and associated methods of making and using a feeder arrangement. The feeder arrangement generally includes a hopper, a feed trough arranged to received feed from the hopper, and a rain guard. In one aspect, the feeder arrangement includes a moveable rain guard extension. The moveable rain guard extension is positionable about a perimeter of the rain guard and shields the feed trough from directional rain. In another aspect, the feeder arrangement includes a lid. The hopper, lid, and rain guard have a shielding, overlapping seam arrangement that sheds water.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a perspective view of a prior art self-dispensing feeder;

FIG. 2 is a perspective view of one embodiment of a self-dispensing feeder having a rain guard and a rain guard extension shown in a shielding position, in accordance with the principles of the present disclosure;

FIG. 3 is a perspective view of the feeder of FIG. 2, shown with the rain guard extension in a maintenance position;

FIG. 4 is an exploded view of the feeder of FIG. 2; and

FIG. 5 is a cross-sectional view of the feeder of FIG. 2.

### DETAILED DESCRIPTION

Reference will now be made in detail to various features of the present disclosure that are illustrated in the accompanying drawings. Wherever possible, the same reference numbers will be used throughout the drawings to refer to the same or like parts.

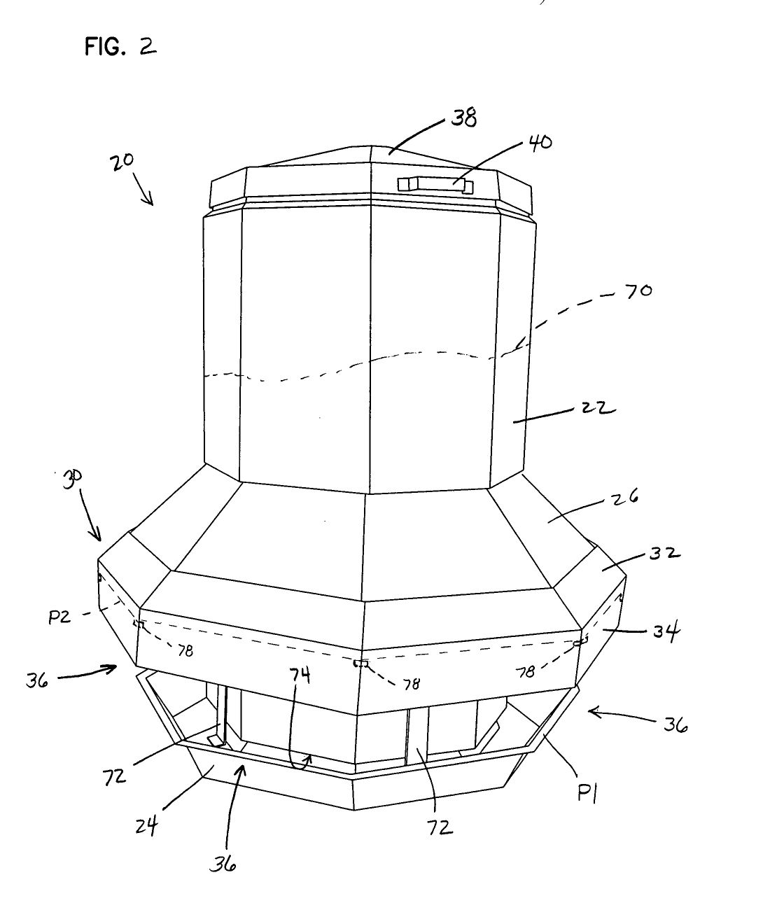

FIGS. 2-5 illustrate a self-dispensing feeder 20 having features that are examples of how inventive aspects in accordance with the principles of the present disclosure may be practiced. Preferred features are adapted for safely feeding animals, including domesticated animals such as sheep and goats, for example; wild animals such as deer, for example; and domesticated and wild birds, such as chickens and pheasants, for example. Preferred features are also adapted for ease of use and ease of feeder maintenance, and for maintaining feed quality.

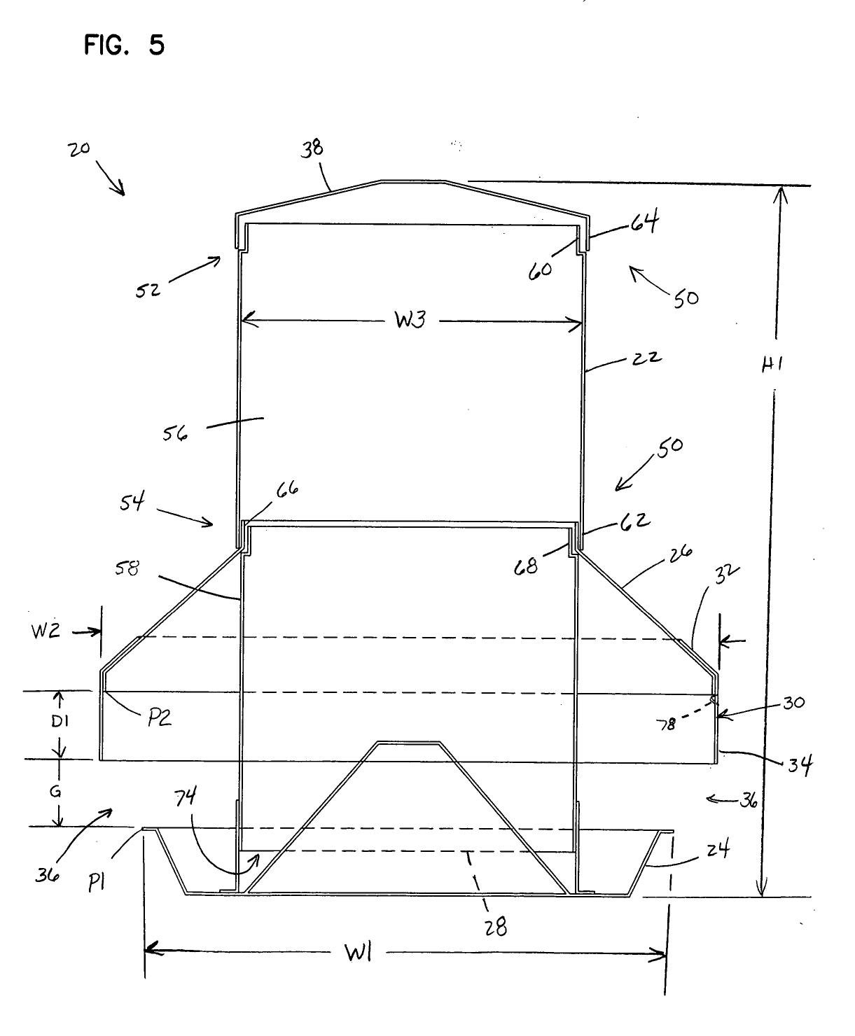

Referring to FIG. 2, the feeder 20 of the present disclosure generally includes a hopper 22, a feed trough 24, and a rain guard 26. The feed trough 24 is arranged in relation to the hopper 22 to receive feed through a bottom opening 28 (FIG. 5) in the hopper 22. In particular, the feed trough 24 and the hopper 22 are positioned relative to one another to provide an opening 74 (see also FIG. 5) between the hopper 22 and feed trough 24 through which feed is dispensed.

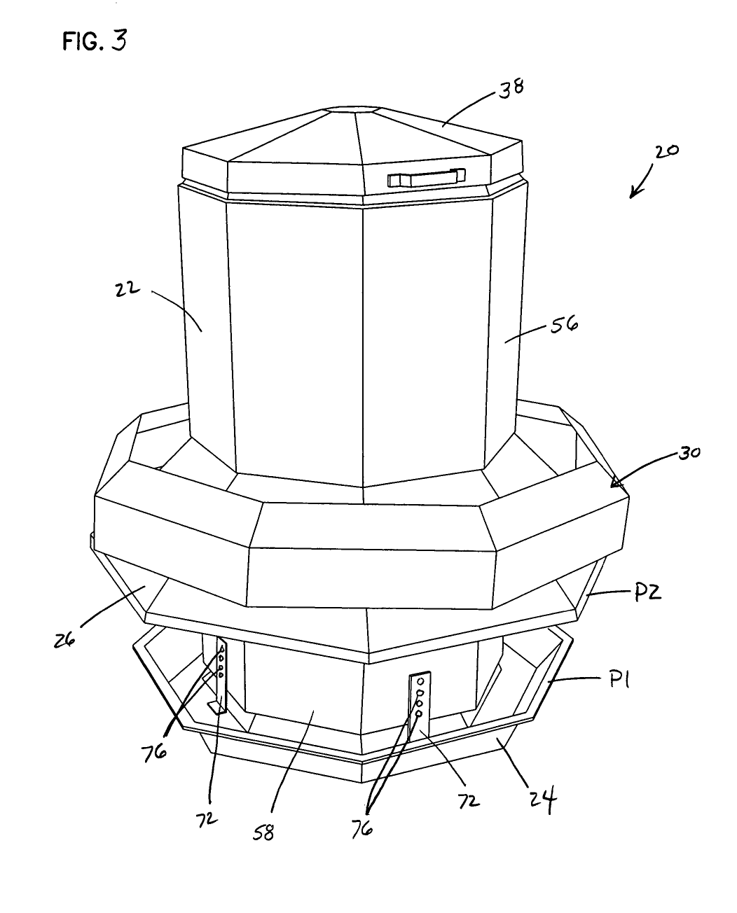

Preferably, the opening 74 is adjustable so that a user can selectively determine the dispense rate of feed. In the illustrated embodiment, the feed trough 24 and the hopper 22 are positionable in a number of positions relative to one another by brackets 72. The brackets 72 can be used to adjust the position of the hopper 22 relative to the feed trough 24 to vary the size of the opening 74, and thereby vary and control the dispense rate of feed. In the illustrated embodiment shown in FIG. 3, the brackets 72 include a number of holes 76 for receipt of fasteners (not shown) that secure the feed trough 24 and the hopper 22 in the selected relative position.

Referring to FIG. 3, the feed trough 24 has an outer perimeter P1. The rain guard 26 has a perimeter P2. The perimeter P2 of the rain guard 26 is sized to extend beyond the outer perimeter P1 of the feed trough 24 (see also FIG. 5). In the illustrated embodiment, the outer perimeter P1 of the feed trough 24 has a general width W1 of between 30 inches and 50 inches; typically about 40 inches. The perimeter P2 of the rain guard 26 has a general width W2 of between 36 inches and 56 inches; typically about 46 inches. In the example embodiment, the rain guard 26 provides about a 3-inch overhang to protect the feed trough 24 from downward rain.

Referring now to FIG. 5, the feeder 20 has an overall height H1 and an overall width W3; although the disclosed principles can be applied in a variety of sizes and applications. The overall height H1 of the feeder 20 is defined between the bottom of the feed trough 24 and the top of a lid 38 of the feeder 20. The overall height H1 is preferably between 24 inches and 74 inches. In one embodiment, the overall height is approximately 60 inches. In another embodiment, the overall height H1 is approximately 39 inches. The overall width W3 of the feeder 20 is preferably between 20 inches and 30 inches; typically about 26 inches. The combined width W3 and height H1 of the disclosed example feeder configurations results in a feeder embodiment having an 800-lb feed capacity, and a feeder embodiment having a 400-lb feed capacity.

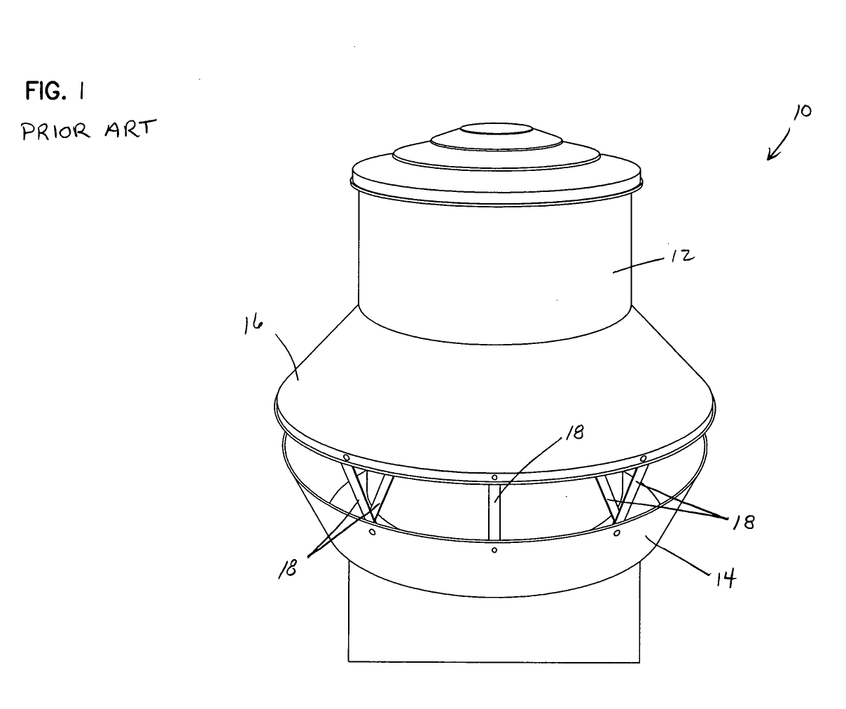

Referring back to FIG. 2, the rain guard 26 of the disclosed feeder 20 preferably has a rigid construction that resists deflection and eliminates the need for gussets or other structural supports (such as the gussets 18 shown in FIG. 1). In the illustrated embodiment, the rigid construction of the rain guard 26 is provided by the polygonal shape of the rain guard 26. The polygonal shape provides a truss-like construction that is relatively rigid in comparison to simple conical rain guards, for example. The rain guard 26 shown in FIG. 2 is octagonal in shape; although other polygonal shapes, such as square, retangular, and pentagonal shapes can be used.

The rigid construction of the octagonal rain guard 26 is self-supporting. Conventional conical-shaped rain guards are typically non-self-supporting and flimsy. Because the present rain guard 26 is self-supporting, the disclosed feeder 20 provides an obstruction-free feeding region 36. What is meant by obstruction-free is that the feeder 20 does not have gussets (e.g. 18, FIG. 1) or other supports within the feeding region 36 (see also FIG. 5) defined between the feed trough 24 and the rain guard 26. The gussets and supports of conventional rain guards block access to the feed trough and create the potential for an animal to catch its head within the feeder. The obstruction-free region 36 also makes cleaning and maintenance of the feeder trough 24 much easier for the user.

Referring still to FIG. 2, the feeder 20 of the present disclosure further includes a rain guard extension 30. The extension 30 is positioned about the perimeter P2 (FIG. 5) of the rain guard 26. Preferably, the rain guard extension 30 has a shape corresponding to the shape of the perimeter P2 of the rain guard 26. Accordingly, in the illustrated embodiment, the extension 30 is octagonal in shape.

Referring to FIGS. 2 and 5, the extension 30 includes a flange portion 32 interconnected to a shield portion 34. The flange portion 32 rests upon the perimeter P2 of the of the rain guard 26 during use. The extension 30 is preferably supported only by the rain guard 26 to accommodate the obstruction-free feeding region 36 feature of the present feeder 20 (FIG. 5). The shield portion 34 depends downwardly from the perimeter P2 of the rain guard 26 (i.e., from the flange portion 32 at the perimeter P2 of the rain guard) to guard the feed trough 24 from directional rain. In the illustrated embodiment, the shield portion 34 depends vertically downward in relation to the perimeter P2 of the rain guard 26. In an alternative embodiment, the shield portion can angle or flare outward in a downwardly direction.

As shown in FIG. 5, the shield portion 34 extends downwardly from the perimeter P2 of the rain guard 26 a distance D1. Preferably, the distance is between about 2 inches and 8 inches. In the illustrated embodiment, the distance D1 is about 5 inches. A corresponding gap G provided between the feed trough 24 and the shield portion 34 of the extension 30 is between about 1 inch and 9 inches. In one embodiment, the gap G is adjustable to accommodate various uses and configurations of the feeder 20. The gap G can be adjusted by providing an extension 30 with an adjustable shield portion (not shown). In the alternative, the gap G can be adjusted by providing an arrangement whereby the overall position of the extension 30 is adjustable in relation to the rain guard 24 or adjustable in relation to the feed trough 24.

In one embodiment, the rain guard extension 30 can includes dimples or detents 78 (shown in dashed lines in FIGS. 2 and 5). The detents 78 can be provided in rain guard extensions manufactured from lighter-weight materials. The detents 78 of the extension 30 function to snap-fit to or engage with the perimeter P2 of the rain guard 26 to ensure that the extension remains securely in place in strong winds.

Preferably the rain guard extension 30 is moveable between a shielding position (shown in FIG. 2) and a maintenance position (shown in FIG. 3). In the illustrated embodiment, the moveable rain guard extension 30 is removable. That is, the extension 30 can be removed from the rain guard 26 and the feeder 20. In the alternative, the extension 30 can be interconnected to the rain guard 26 but moveable between the shielding position and the maintenance position, such as by a segmented hinge connection, for example.

In the shielding position, as shown in FIG. 2, the rain guard extension 30 guards against rain driven by wind. During windy rains, rain can be blown into conventional feed trough arrangements causing feed contamination and spoilage. The extension 30 of the present disclosure prevents directional rain from entering the feed trough 24. Yet in the shielding position, access to the feed trough for cleaning or maintenance purposes is also more difficult. Although, the rain guard 26 can be permanently fixed in position, it is preferred that the extension 30 is movable from the shielding position to the maintenance position.

In the maintenance position, as shown in FIG. 3, the extension 30 provides better access to the feed trough 24 for maintenance or cleaning purposes. That is, the access provided to the feed trough 24 is greater than the feeding access provided when the extension 30 is positioned about the perimeter P2 of the rain guard 26. The greater access is needed to reach areas of the feed trough 24 for maintenance or cleaning purposes, which areas would otherwise not be reached if the extension 30 were permanently fixed to the rain guard 26.

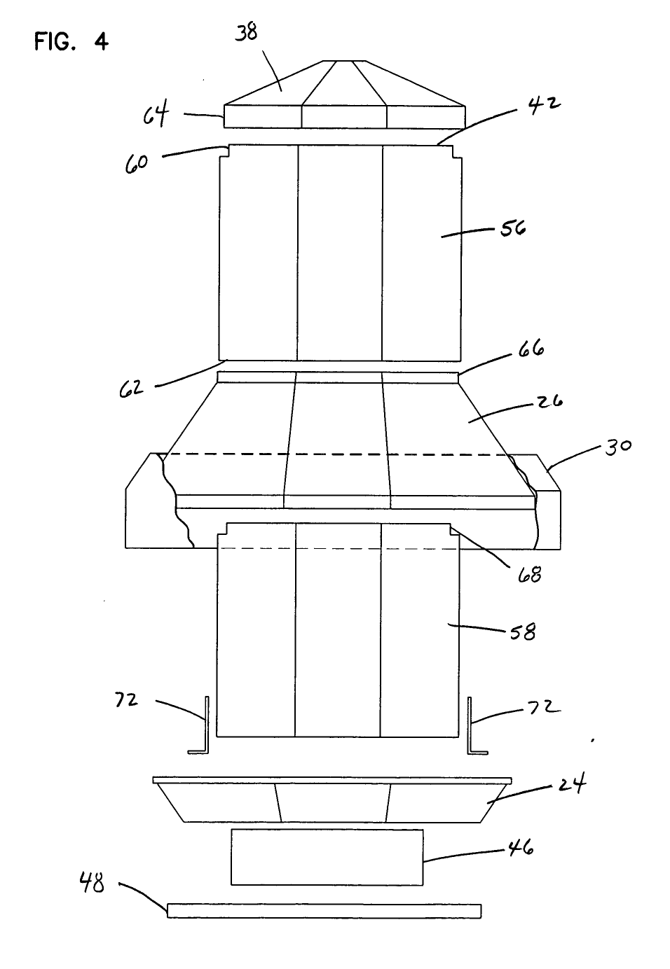

Referring back to FIG. 2, the lid 38 of the feeder 20 is positionable to cover a top opening 42 (FIG. 4) of the hopper 22. In the illustrated embodiment, the lid 38 includes a handle 40 for removing the lid 38 to access and/or fill the hopper 22. The feeder 20 can include a lid lock or other securing device (not shown) to prevent the lid 38 from blowing off the feeder 20 in the wind.

Referring now to FIG. 4, the feeder 20 can also include a riser 46 (FIG. 4). The riser 46 is positioned beneath the feed trough 24 to raise the feed trough 24 for feeding animals that have difficultly feeding from the ground. For example, in one method of use, the feed trough 24 of the feeder 20 rests upon the ground for feeding pheasant or chickens. Yet in the alternative, the riser 46 can be provided to raise the feeder 20 from the ground for feeding sheep or goats. In the illustrated embodiment of FIG. 4, skids 48 (only one shown) are attached to the riser 46. The skids 48 can be used for transportation of the feeder 20. As can be understood, the riser 46 and skids 48 can be sized to raise the feeder 20 a variety of distances from the ground. The riser 46 and skids 48 are sized and constructed to raise the feeder a distance from the ground, depending upon the use of the feeder. For sheep, for example, the riser 46 and skids 48 are sized to raise the feeder typically about 8 to 10 inches from the ground; although the disclosed principles can be applied in a variety of sizes and applications.

The skids 48 can also be used in applications requiring additional feeder stabilization. The skids 48 typically have a length that is greater than the width of the feeder trough 24. Accordingly, the skids function to stabilize feeders having taller hopper constructions, for example. In addition, the skids 48 can be of varying heights to adapt the feeder for use on an incline or uneven ground surfaces.

Referring now to FIGS. 4 and 5, the feeder 20 of the present disclosure preferably has a shielding, overlapping seam arrangement 50 that sheds water or rain. What is meant by a shielding, overlapping seam arrangement is an arrangement having seams that overlap like shingles on a roof so that rain runs over the seams without chance of seeping or running into the seam. The shielding, overlapping seam arrangement 50 provides a sealed hopper enclosure that maintains feed quality, without welding or the use of sealants and/or adhesives.

The shielding, overlapping seam arrangement 50 of the present disclosure includes a first overlapping seam 52 and a second overlapping seam 54. The first overlapping seam 52 is located between the lid 38 and the hopper 22. The second overlapping seam 54 is located between the hopper 22 and the rain guard 26.

The hopper 22 of the presently disclosed feeder 20 includes an upper hopper portion 56 and a lower hopper portion 58. The upper hopper portion 56 defines the top opening 42 of the feeder 20, and the lower hopper portion 58 defines the bottom opening 28 of the feeder 20. In yet another embodiment, the feeder 20 can include an optional third hopper portion (not shown) that permits a user to increase hopper capacity if desired. A number of additional hopper portions that expand feeder capacity and that interconnect in an overlapping manner in accordance with the principles disclosed can be provided.

Referring still to FIGS. 4 and 5, the upper hopper portion 56 has an inner hopper edge 60 and an outer hopper edge 62. The inner hopper edge 60 of the upper hopper portion 56 defines the top opening 42 of the hopper 22. The lid 38 has an outer lid edge 64. The outer lid edge 64 of the lid 38 overlaps the inner hopper edge 60 of the upper hopper portion 56. The overlapping outer lid edge 64 and inner hopper edge 60 define the first overlapping seam 52 of the shielding, overlapping seam arrangement 50.

The rain guard 26 also includes an inner rain guard edge 66. The outer hopper edge 62 of the upper hopper portion 56 overlaps the inner rain guard edge 66 of the rain guard 26. The overlapping outer hopper edge 62 and the inner rain guard edge 66 define the second overlapping seam 54. The lower hopper portion 58 also has an inner hopper edge 68. The outer hopper edge 62 of the upper hopper portion 56 also overlaps the inner hopper edge 68 of the lower hopper portion 58, and further defines the second overlapping seam 54. It is noted that while the rain may run under the extension 30, the rain guard 26 still extends beyond the perimeter P1 of the feed trough 24 so that any such rain runs down the rain guard 26 and the inside of the shield portion 34 of the extension 30, and onto the ground, as opposed to into the feed trough 24.

As previously described, the rain guard 26 of the present feeder 20 is preferably supported without the use of gussets or other structural supports that would compromise the feature of the obstruction-free feeding region 36. In the illustrated embodiment, the rain guard 26 is supported only at the second overlapping seam 54 of the feeder 20. In particular, the edge 66 of the rain guard 26 is supported by the edge 68 of the lower hopper portion 58 and retained between the upper and lower hopper portions 56, 58. Because of the previously described rigid construction of the rain guard 26, no additional support or gussets are required so that the feeding region 36 is free of obstructions. Preferably, the obstruction-free feeding region 36 of the illustrated feeder 20 extends around the entire outer perimeter P1 of the feed trough 24.

Referring again to FIGS. 2 and 3, in use, the hopper 22 of the feeder 20 is filled by removing the lid 38 from the upper portion 56 of the hopper 22. The handle 40 of the lid 38 can be used to hang the lid 38 on the hopper 22, for example, on a lid lock (not shown) provided to secure the lid 38 to the hopper 22. This permits the user to fill the hopper 22 without having to place the lid 38 on the ground and risk contaminating the feed with dirt that may be carried by the lid 38 when the lid is placed back over the top opening 42 of the hopper 22.

When the hopper 22 is filled with a desired amount of feed, the lid 38 is placed on the hopper 22 to protect the feed from rain or water. The feed is gravity-fed and self-dispensed into the feed trough 24 through the bottom opening 28 of the hopper 22. In conventional arrangements, to maintain the feed level in a hopper, the user is required to remove a cover to view the level of feed, or wait until the feed trough is empty. Preferably, the amount of feed contained within the hopper 22 of the present feeder 20 can be monitored by viewing the level of feed 70 (represented by dashed line in FIG. 2) through the hopper 22. That is, the hopper 22 is preferably made of a material that visually shows the level of feed 70 contained within the hopper 22, without having to remove the lid 38 from the hopper 22. In one embodiment, the hopper 22 is made of semi-transparent material, such as polyethylene, for example. Other types of materials in accordance with the principles disclosed can be used.

In the illustrated embodiment, each of the lid 38, the hopper 22, the rain guard 26, and the feed trough 24 is made of a molded construction. By molding the components of the feeder 20, tightly-fitting dimensions that compliment the shielding, overlapping seam arrangement 50 of the feeder (such as the diameters of the edges 60, 62, 64, 66, 68 of the components) can be easily and cost-effectively provided. Each of the components can be made of a similar material, such as polyethylene, or made of different materials. Other types of construction and materials in accordance with the principles disclosed can be used.

Referring still to FIGS. 2 and 3, the rain guard extension 30 of the feeder 20 is positioned about the rain guard 26 to shield the dispensed feed within the trough 24 from directional rain. To maintenance the feed trough 24 or feeder 20, the rain guard extension 30 can be moved or lifted from the rain guard 26 to access the feed trough 24.

In one method, the extension 30 is completely removed from the feeder 20. In another method, the extension 30 is lifted from the rain guard 26, rotated, and placed such that the extension 30 rests upon the rain guard 26, as shown in FIG. 3. The rain guard extension 30 simply rests upon the rain guard 26 in the maintenance position without sliding down due to the non-conical or octagonal shape of the extension 30 and the rain guard 26.

By removing or moving the extension 30 to the maintenance position, the feed trough 24 is exposed for cleaning or other maintenance. When maintenance is complete, the extension 30 can be re-positioned about the perimeter P2 of the rain guard 26 to again shield the dispensed feed within the trough 24 from directional rain.

The above specification provides a complete description of the present invention. Since many embodiments of the invention can be made without departing from the spirit and scope of the invention, certain aspects of the invention reside in the claims hereinafter appended.

1. A self-dispensing feeder, comprising:
a) a hopper;
b) a feed trough arranged to receive feed from the hopper;
c) a rain guard having a perimeter that extends beyond an outer perimeter of the feed trough;
d) a movable rain guard extension positioned about the perimeter of the rain guard, the rain guard extension having a shield that depends downward from the perimeter of the rain guard to guard against directional rain.

2. The feeder of claim 1, wherein the rain guard extension includes a flange that rests upon the perimeter of the rain guard during use.

3. The feeder of claim 2, wherein the movable rain guard extension is positionable in a first position that shields the feed trough from directional rain, and a second position that provides access to the feed trough for maintenance purposes.

4. The feeder of claim 2, wherein the rain guard extension is supported only by the rain guard to provide an obstruction-free feeding region.

5. The feeder of claim 4, wherein the obstruction-free feeding region extends around the entire outer perimeter of the feed trough.

6. The feeder of claim 1, wherein the hopper is made of a material that visually shows the level of feed contained within the hopper.

7. The feeder of claim 1, wherein the rain guard has a rigid construction that resists deflection and eliminates the need for support gussets.

8. The feeder of claim 1, wherein the perimeter of the rain guard is octagonal in shape.

9. The feeder of claim 1, further including a lid that covers a top opening of the hopper, the lid, hopper, and rain guard having a shielding, overlapping seam arrangement that sheds water.

10-16. (canceled)

17. A method of using a feeder, the feeder including a hopper, a trough, and a rain guard, the method of using including:
a) removing a lid from the hopper;
b) filling the hopper with an amount of feed; and
c) positioning a rain guard extension about the rain guard of the feeder, the rain guard extension including a portion that depends downward from a perimeter of the rain guard to shield the trough from directional rain.

18. The method of claim 17, further including moving the rain guard extension from the position that shields the trough from directional rain to a position that provides access to the trough.

19. The method of claim 18, further including maintaining the feeder and re-positioning the rain guard extension about the rain guard of the feeder to shield the trough from directional rain.

20. The method of claim 17, further including monitoring the amount of feed contained within the hopper by viewing the feed through hopper without removing the lid from the hopper.
